(19) United States
(12) Patent Application Publication
(10) Pub. No.: US 2023/0032056 A1
(43) Pub. Date: Feb. 2, 2023

(54) PILL BOX

(71) Applicant: E-LINK PLASTIC & METAL INDUSTRIAL CO., LTD., NEW TAIPEI CITY (TW)

(72) Inventor: PIN-YANG CHANG, NEW TAIPEI CITY (TW)

(21) Appl. No.: 17/444,236

(22) Filed: Aug. 2, 2021

(51) Int. Cl. B65D 43/02; B65D 5/48

(52) U.S. Cl. CPC B65D 43/0204; B65D 5/48002; B65D 2543/00194; B65D 2585/56

(57) ABSTRACT

A pill box has a container and a main lid. The container has multiple storage compartments and a peripheral wall. The peripheral wall surrounds the storage compartments and forms an upper opening. The storage compartments communicate with the upper opening. The main lid is connected to the container, and has a dividing grid and multiple compartment lids. The dividing grid is pivotally connected to the container and has multiple storage compartment openings. The compartment lids are mounted on the dividing grid and are capable of covering or opening the storage compartment respectively. When the dividing grid pivots away from the container, the compartment lids are moved away from the storage compartments, and the upper opening of the container is open. Therefore, to load medications into the storage compartments, a user only has to open and close the main lid, making the pill box easier to use.

### BACKGROUND OF THE INVENTION

### 1. Field of the Invention

The present invention relates to a pill box, especially to a pill box that is portable and has multiple compartments for organizing scheduled doses of pills.

### 2. Description of the Prior Arts

A pill box has multiple independent storage compartments, and each one of the storage compartments has an exclusive flip lid. Pills are stored in the storage compartments respectively according to prescribed doses and frequencies of medications as a reminder to take correct doses of medications in compliance with prescription. For example, when the user has to take medication 3 times per day for 7 consecutive days, a 21-compartment pill box can be used for storing the medications.

However, to load medications into the storage compartments of a conventional pill box, the user needs to open the flip lids of all the storage compartments. That is, to load medications into the 21-compartment pill box, the user has to open and close the 21 flip lids one by one, making the conventional pill box inconvenient to use, especially for physically challenged users such as users with limited finger manipulation capabilities.

To overcome the shortcomings, the present invention provides a pill box to mitigate or obviate the aforementioned problems.

### SUMMARY OF THE INVENTION

The main objective of the present invention is to provide a pill box with all storage compartments thereof openable in one single manipulation step.

The pill box has a container and a main lid. The container has a container-dividing structure, a peripheral wall, at least one container locking portion, a dividing grid, and multiple compartment lids. The container-dividing structure forms multiple storage compartments. The peripheral wall surrounds the container-dividing structure and forms an upper opening. The storage compartments communicate with the upper opening. The at least one container locking portion is formed on the peripheral wall. The main lid is connected to the container. The main lid has a dividing grid and multiple compartment lids. The dividing grid is pivotally connected to the container and has at least one compartment locking portion selectively engaging with the at least one container locking portion of the container. The compartment lids are mounted on the dividing grid. The pill box has a general status and a loading status. In the general status, a bottom surface of the dividing grid of the main lid abuts on a periphery of the upper opening of the container such that the upper opening is closed. The at least one compartment locking portion engages with the at least one container locking portion of the container. Each one of the compartment lids corresponds in position to a respective one of the storage compartments, and is capable of covering or opening said storage compartment. In the loading status, the bottom surface of the dividing grid of the main lid is detached from the periphery of the upper opening of the container such that the compartment lids are moved away from the storage compartments and the upper opening of the container is open.

To take medications stored in the present invention, a user opens one of the storage compartments by opening the corresponding compartment lid of the main lid. The procedure for taking medications from the present invention is the same as a conventional pill box.

To load medications into the storage compartments, the user first opens the main lid. When the main lid is opened, the upper opening of the container is uncovered, and all compartment lids are moved away from the storage compartments. As a result, all storage compartments are opened as the main lid is opened; that is, all storage compartments are opened in one single manipulation step such that the user can load medications into all storage compartments. After putting medications into the storage compartments, the user closes the main lid to complete the procedure for loading medications.

In short, to load medications into the storage compartments, the user only has to open and close the main lid. As a result, the present invention greatly simplifies the manipulation steps required for loading medications, and is therefore easier to use.

The advantage of the present invention is further having the main lid and the compartment lids that are mounted on the main lid. The compartment lids allow a user to take medications from the present invention in the same way as a conventional pill box. The main lid further enables the user to load the medications into the storage compartments with only one open-and-close manipulation, thereby greatly simplifying the manipulation steps required for loading medications, and is therefore easier to use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pill box in accordance with the present invention, showing the pill box in a general status;

FIG. 2 is a perspective view of the pill box in FIG. 1, showing the pill box in a loading status;

FIG. 3 is an exploded perspective view of the pill box in FIG. 1;

FIG. 4 is a sectional view of the pill box along a cutting plane line 4-4 in FIG. 1;

FIG. 5 is an operational sectional view of the pill box in FIG. 4, showing a main lid of the pill box being opened; and

FIG. 6 is an enlarged sectional view of the pill box along a cutting plane line 6-6 in FIG. 1, showing a compartment lid of the pill box being opened.

### DETAILED DESCRIPTION OF THE PREFERRED EMBODIMENTS

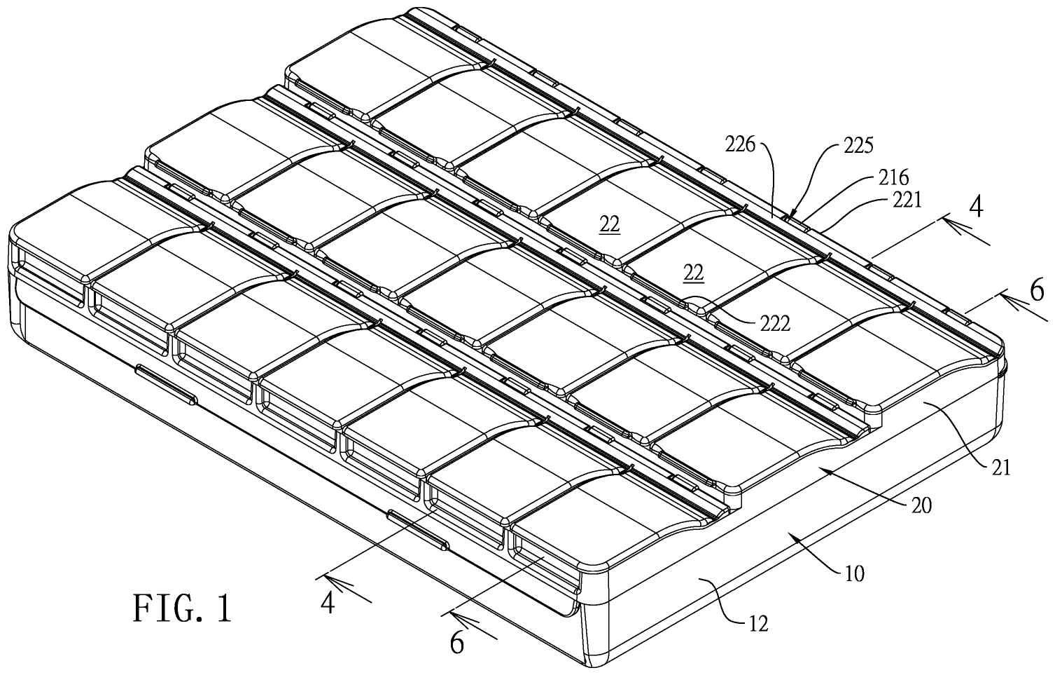

With reference to FIGS. 1 to 3, a pill box in accordance with the present invention comprises a container 10 and a main lid 20.

The container 10 has a container-dividing structure 11, a peripheral wall 12, and two container locking portions 13. In the preferred embodiment, the container 10 further has multiple positioning strips 14.

The container-dividing structure 11 forms multiple storage compartments 101. The peripheral wall 12 surrounds the container-dividing structure 11 and forms an upper opening. The storage compartments 101 of the container-dividing structure 11 communicate with the upper opening; that is, medications can be put into the storage compartments 101 via the upper opening.

The two container locking portion 13 are formed on the peripheral wall 12 and disposed apart from each other along a widthwise direction of the container 10. Each one of the container locking portions 13 is a snap protruded from the peripheral wall 12. In another preferred embodiment, the number of the container locking portion 13 is one. The positioning strips 14 are formed on and protrudes from a top surface of the container 10. The positioning strips 14 are disposed apart from each other. Some of the positioning strips 14 are formed on the top of the peripheral wall 12.

The main lid 20 is connected to the container 10 and is capable of covering or opening the upper opening of the container 10. The main lid 20 has a dividing grid 21 and multiple compartment lids 22.

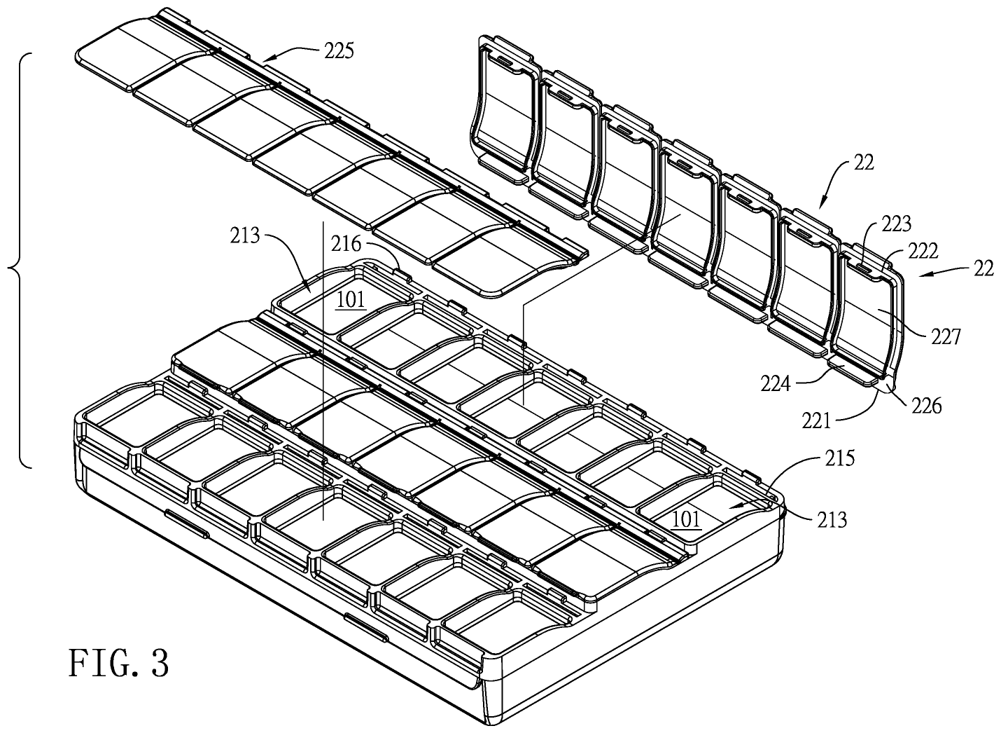

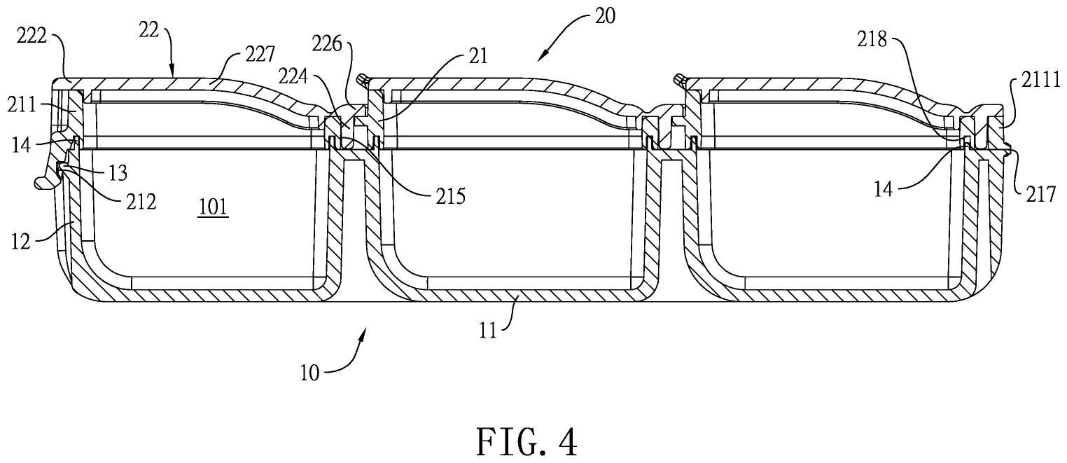

With reference to FIGS. 3 to 5 and FIG. 6, the dividing grid 21 is pivotally connected to the container 10. The dividing grid 21 is preferably integrally formed with the container 10. The dividing grid 21 has two compartment locking portions 212. In the preferred embodiment, the dividing grid 21 further has an outer frame 211, multiple storage compartment openings 213, multiple grid engaging portions 214, multiple grid connecting recesses 215, multiple indicating blocks 216, and multiple positioning recesses 218. The outer frame 211 corresponds in shape to a periphery of the upper opening of the container 10; that is, a contour of the outer frame 211 is substantially same as a contour of the periphery of the upper opening. The outer frame 211 has a grid connected edge 2111 that is pivotally connected to the periphery of the upper opening of the container 10. To be specific, the grid connected edge 2111 is connected to the container 10 via a hinge portion 217 (as shown in FIG. 4) such that the dividing grid 21 is capable of flipping relative to the container 10. A bottom surface of the outer frame 211 selectively abuts on the periphery of the upper opening of the container 10. The two compartment locking portions 212 are formed on the outer frame 211 and selectively engaged with a respective one of the two container locking portions 13. Each one of the compartment locking portions 212 is a recess in the preferred embodiment. In another preferred embodiment, the number of the compartment locking portion 212 is one.

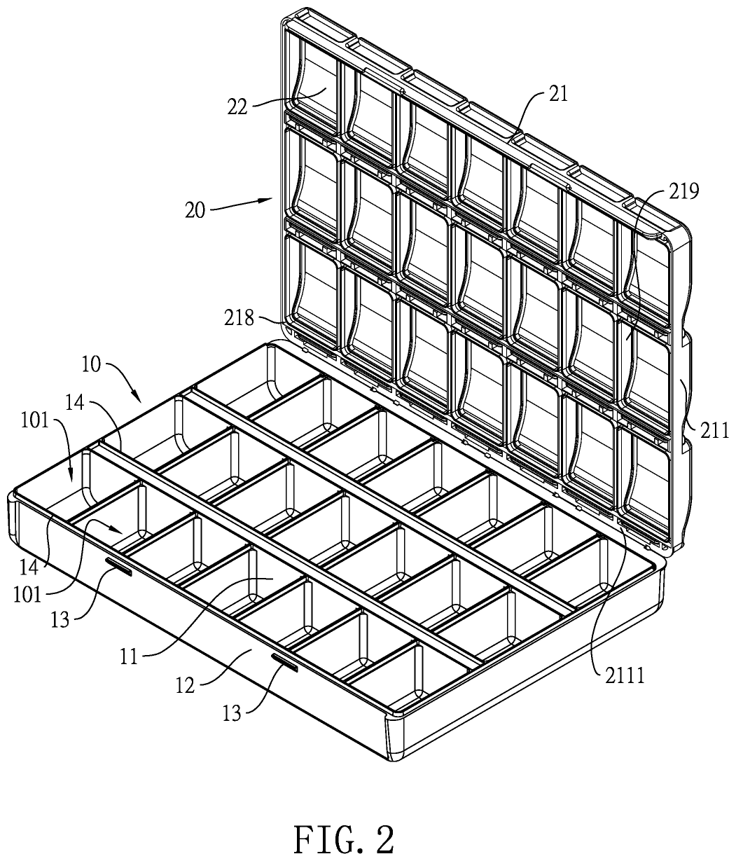

With reference to FIGS. 2 and 3, in the preferred embodiment, the storage compartment openings 213 are formed solely by the dividing grid 21. To be precise, the outer frame 211 surrounds the inner frame 219, and the inner frame 219 divides the upper opening formed by the outer frame 211 into the storage compartment openings 213. A number of the storage compartment openings 213 equals to a number of the storage compartments 101. When the dividing grid 21 pivots toward the container 10 such that the bottom surface of the outer frame 211 abuts on the periphery of the upper opening of the container 10, each one of the storage compartments 101 is aligned to a respective one of the storage compartment openings 213, and a bottom surface of the inner frame 219 abuts on the top surface of the container-dividing structure 11 such that each one of the storage compartment openings 213 is connected only to the corresponding one of the storage compartments 101 to prevent medications from moving to adjacent storage compartments 101.

The storage compartment openings 213 are not limited to be formed solely by the dividing grid 21. In another preferred embodiment, the storage compartment openings 213 are present only when the dividing grid 21 abuts on structure of the container 10 such as the dividing grid 21; that is, the dividing grid 21 does not form all the storage compartment openings 213 by itself. The storage compartment openings 213 are formed by the dividing grid 21 and the container 10 together. For example, the dividing grid 21 itself forms only 3 elongated holes that extend along the widthwise direction of the container 10, and the container-dividing structure 11 protrudes from the periphery of the upper opening such that when the dividing grid 21 abuts on the container 10, said 3 elongated holes are divided into the storage compartment openings 213 by the container-dividing structure 11.

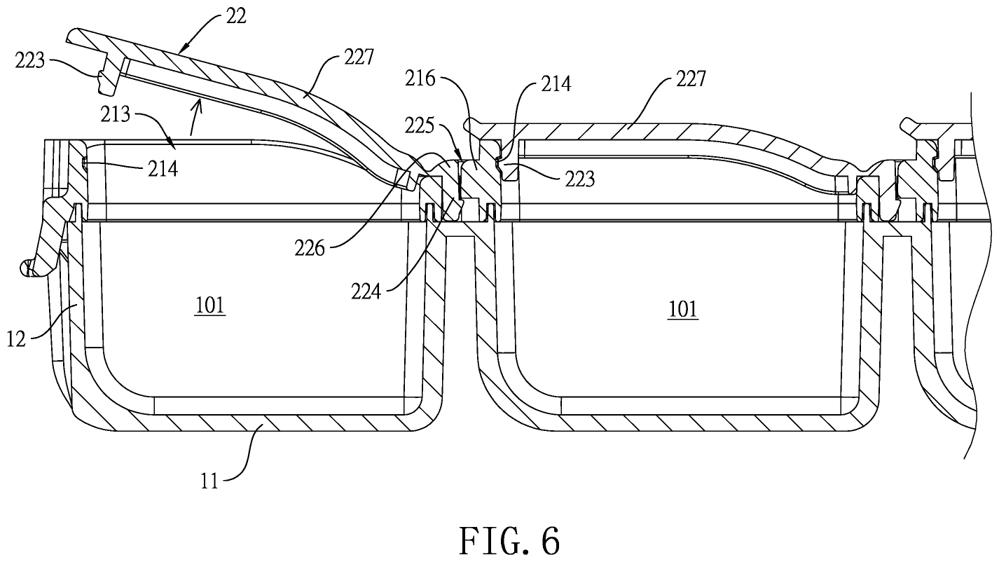

With reference to FIGS. 3 and 6, each one of the grid engaging portions 214 is formed in a periphery of a respective one of the storage compartment openings 213. To be precise, each one of the grid engaging portions 214 is a recess.

The grid connecting recesses 215 are formed in a top surface of the dividing grid 21. The indicating blocks 216 are formed on and protruded from the top surface of the dividing grid 21. Each one of the indicating blocks 216 corresponds in position to a respective one of the storage compartment openings 213.

The positioning recesses 218 are formed in the bottom surface of the dividing grid 21, and the positioning recesses 218 are disposed apart from each other. Some of the positioning recesses 218 are formed in the outer frame 211. When the bottom surface of the outer frame 211 abuts on the periphery of the upper openings of the container 10, each one of the positioning strips 14 of the container 10 is mounted in a respective one of the positioning recesses 218 to prevent the dividing grid 21 from moving in transverse direction relative to the container 10.

The compartment lids 22 are mounted on the dividing grid 21, and each one of the compartment lids 22 corresponds in position to a respective one of the storage compartments 101 of the container 10. When the bottom surface of the outer frame 211 abuts on the periphery of the upper opening of the container 10, each one of the compartment lids 22 is capable of covering or opening the corresponding storage compartment 101. To be specific, the compartment lids 22 cover or open the storage compartments 101 via covering or opening the storage compartment openings 213.

In the preferred embodiments, the compartment lids 22 are detachably mounted on the dividing grid 21. Each one of the compartment lids 22 is pivotable relative to the dividing grid 21 to cover or open the corresponding storage compartment opening 213.

To be specific, each one of the compartment lids 22 has a connecting portion 226, a covering portion 227, a connected edge 221, an engaged edge 222, a compartment engaging portion 223, a compartment connecting block 224, and an indicating recess 225. The connected edge 221 is formed on the connecting portion 226. The engaged edge 222 is formed on the covering portion 227. The connected edge 221 and the engaged edge 222 are disposed opposite each other.

The compartment connecting block 224 is protruded from the connecting portion 226 and is detachably mounted in and engages with a respective one of the grid connecting recesses 215 of the dividing grid 21. As a result, the compartment lids 22 can be detached from the dividing grid 21 for ease of cleaning. The covering portion 227 is connected to the connecting portion 226, and is pivotable relative to the connecting portion 226 to cover or open the corresponding storage compartment 101.

In another preferred embodiment, each compartment lid 22 is a simple lid; that is, each compartment lid 22 does not have the connecting portion 226 and the covering portion 227 that can pivot relative to each other. The connected edge 221 and the engaged edge 222 are two opposite edges of the compartment lid 22 respectively, and the connected edge 221 is pivotally connected to the dividing grid 21 such that the compartment lid 22 is pivotable relative to the dividing grid 21.

The compartment engaging portion 223 is formed on the engaged edge 222. To be precise, the compartment engaging portion 223 is a protruded block. When the compartment lid 22 covers the corresponding storage compartments 101, the compartment engaging portion 223 engages with a respective one of the grid engaging portion 214 of the dividing grid 21 to prevent the compartment lid 22 from pivoting relative to the dividing grid 21 such that the compartment lid 22 maintains a status of covering the storage compartment opening 213.

The indicating recess 225 is defined through a top surface and a bottom surface of the compartment lid 22, and the indicating recess 225 is detachably located around a respective one of the indicating blocks 216 of the dividing grid 21. Each one of the indicating blocks 216 fits flush in or protrudes out of the corresponding indicating recess 225 to indicate whether the compartment lid 22 has been pressed to a correct mounting position when reconnecting the compartment lid 22 to the dividing grid 21.

In the preferred embodiment, at least two of the compartment lids 22 are connected to each other for ease of detaching the compartment lids 22. To be precise, the compartment lids 22 are arranged in 3 rows, and each one of the compartment lids 22 in the same row is connected to the adjacent ones of the compartment lids 22.

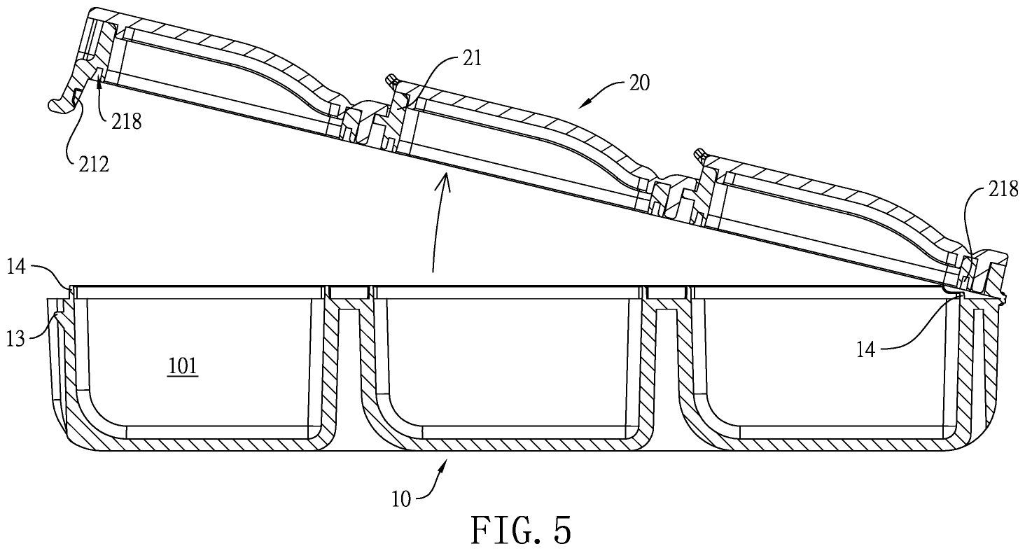

With reference to FIGS. 1, 2, 4, and 5, the present invention has a general status (as shown in FIGS. 1 and 4) and a loading status (as shown in FIGS. 2 and 5).

In the general status, the bottom surface of the dividing grid 21 abuts on the periphery of the upper opening of the container 10 and surrounds the periphery of the upper opening of the container 10. The storage compartment openings 213 communicate with the storage compartments 101 of the dividing grid 21 respectively. The compartment locking portions 212 of the dividing grid 21 engage with the container locking portions 13 of the container 10 respectively to prevent the compartment lids 22 from pivoting relative to the dividing grid 21 such that the pill box remains in the general status. The compartment lids 22 are capable of covering or opening the storage compartment openings 213 respectively.

In the general status, medications are stored in the storage compartments 101 respectively. The user may open a specific one of the compartment lids 22 to take medications stored inside.

In the loading status, the dividing grid 21 is pivoted away from the container 10 to detach from the bottom surface of the dividing grid 21 from the periphery of the upper opening such that the compartment lids 22 are moved away from the storage compartments 101 and the upper openings are opened. The user may load the medications into the storage compartments 101 via the upper opening of the container 10.

In summary, the present invention further has the main lid 20 and the compartment lids 22 that are mounted on the main lid 20. The compartment lids 22 allow the present invention to function in a same way as a conventional pill box. The main lid 20 further enables the user to load the medications into the storage compartments 101 with only one open-and-close manipulation, thereby greatly simplifying the manipulation steps required for loading medications, and is therefore easier to use

The present invention further has the main lid 20 and the compartment lids 22 mounted on the main lid 20. The compartment lids 22 allow the user to take medications from the present invention in the same way as a conventional pill box. The main lid 20 further enables the user to load the medications into the storage compartments 101 with only one open-and-close manipulation, thereby greatly simplifying the manipulation steps required for loading medications, and is therefore easier to use

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pill box comprising:
a container having
a container-dividing structure forming multiple storage compartments;
a peripheral wall surrounding the container-dividing structure and forming an upper opening; the storage compartments communicating with the upper opening; and
at least one container locking portion formed on the peripheral wall; and
a main lid connected to the container and having
a dividing grid pivotally connected to the container and having
at least one compartment locking portion selectively engaging with the at least one container locking portion of the container; and
multiple compartment lids mounted on the dividing grid;
the pill box having a general status and a loading status;
in the general status, a bottom surface of the dividing grid of the main lid abutting on a periphery of the upper opening of the container such that the upper opening is closed; the at least one compartment locking portion of the dividing grid engaging with the at least one container locking portion of the container; each one of the compartment lids corresponding in position to a respective one of the storage compartments and being capable of covering or opening said storage compartment;
in the loading status, the bottom surface of the dividing grid of the main lid detached from the periphery of the upper opening of the container such that the compartment lids are moved away from the storage compartments and the upper opening of the container is open.

2. The pill box as claimed in claim 1, wherein the compartment lids of the main lid are detachably mounted on the dividing grid.

3. The pill box as claimed in claim 2, wherein
the dividing grid of the main lid has multiple grid engaging portions; and
each one of the compartment lids of the main lid is pivotable relative to the dividing grid to cover or open the corresponding storage compartment; each one of the compartment lids has
a connected edge detachably connected to the dividing grid;
an engaged edge being opposite to the connected edge; and
a compartment engaging portion formed on the engaged edge and selectively engaging with a respective one of the grid engaging portions of the dividing grid; the compartment engaging portion engaging with the corresponding grid engaging portion when the compartment lid covers the corresponding storage compartment.

4. The pill box as claimed in claim 3, wherein each one of the compartment lids has:
a connecting portion; the connected edge formed on the connecting portion; and
a covering portion connected to the connecting portion; the covering portion being pivotable relative to the connecting portion to cover or open the corresponding storage compartment; the engaged edge formed on the covering portion.

5. The pill box as claimed in claim 4, wherein
multiple grid connecting recesses are formed on a top surface of the dividing grid; and
each one of the compartment lids has a compartment connecting block formed on the connecting portion, and the compartment connecting block is detachably mounted in and engages with a respective one of the grid connecting recesses.

6. The pill box as claimed in claim 2, wherein
multiple indicating blocks are formed on the dividing grid; and
each one of the compartment lids has an indicating recess, and the indicating recess is detachably located around a respective one of the indicating blocks.

7. The pill box as claimed in claim 5, wherein
multiple indicating blocks are formed on the dividing grid; and
each one of the compartment lids has an indicating recess, and the indicating recess is detachably located around a respective one of the indicating blocks.

8. The pill box as claimed in claim 6, wherein
the indicating recess of each one of the compartment lids is defined through a top surface and a bottom surface of the compartment lid; and
each one of the indicating blocks protrudes from a top surface of the corresponding dividing grid, and fits flush in or protrudes out of the corresponding indicating recess.

9. The pill box as claimed in claim 2, wherein at least two of the compartment lids are connected to each other.

10. The pill box as claimed in claim 5, wherein at least two of the compartment lids are connected to each other.

11. The pill box as claimed in claim 1, wherein
multiple positioning strips are formed on and protrude from a top surface of the container and are disposed apart from each other; and
multiple positioning recesses are formed in the bottom surface of the dividing grid and are disposed apart from each other;
in the general status, each one of the positioning strips is mounted in a respective one of the positioning recesses.

12. The pill box as claimed in claim 5, wherein
multiple positioning strips are formed on and protrude from a top surface of the container and are disposed apart from each other; and
multiple positioning recesses are formed in the bottom surface of the dividing grid and are disposed apart from each other;
in the general status, each one of the positioning strips is mounted in a respective one of the positioning recesses.

13. The pill box as claimed in claim 1, wherein
multiple storage compartment openings are formed through the dividing grid;
in the general status, each one of the storage compartment openings communicates with a respective one of the storage compartments of the container; and
each one of the compartment lids is capable of covering or opening a respective one of the storage compartment openings.

14. The pill box as claimed in claim 5, wherein
multiple storage compartment openings are formed through the dividing grid;
in the general status, each one of the storage compartment openings communicates with a respective one of the storage compartments of the container; and
each one of the compartment lids is capable of covering or opening a respective one of the storage compartment openings.
